(19) United States
(12) Patent Application Publication
(10) Pub. No.: US 2017/0077598 A1
(43) Pub. Date: Mar. 16, 2017

(54) PIT LID TRIDENT ANTENNA ARRANGEMENT

(71) Applicant: Aclara Technologies LLC, Hazelwood, MO (US)

(72) Inventors: Lawrence R. Foore, Bay Village, OH (US); Gary D. Mattox, Bedford, OH (US)

(21) Appl. No.: 15/257,624

(22) Filed: Sep. 6, 2016

Related U.S. Application Data
(60) Provisional application No. 62/217,560, filed on Sep. 11, 2015.

(51) Int. Cl. H01Q 1/42; H01Q 5/392; H01Q 1/38; H01Q 1/48

(52) U.S. Cl. CPC H01Q 1/42; H01Q 1/48; H01Q 5/392; H01Q 1/38

(57) ABSTRACT

A trident antenna arrangement (300) is described. The antenna arrangement includes a driving element (302), a first parasitic element (304), a second parasitic element (306), a feed point (308), and a ground plate (309) disposed on a substrate (310). The parasitic elements have different lengths which causes a dual resonance. Operation of the driving element and parasitic elements over the substrate and the ground plate allows the antenna system to be minimally impacted by the conductive material underneath. The antenna arrangement is used to transmit water meter (110) readings from a remote location to a utility.

### CROSS REFERENCE TO RELATED APPLICATIONS

This application is based upon and claims the benefit of U.S. provisional patent application 62/217,560 filed Sep. 11, 2015.

### STATEMENT REGARDING FEDERALLY SPONSORED RESEARCH OR DEVELOPMENT

N/A

### BACKGROUND OF THE INVENTION

The present invention relates to antenna systems for communicating utility meter readings. In particular, but not exclusively, the present invention relates to a trident antenna arrangement associated with a utility meter, particularly a water meter, for remotely transmitting meter readings from a generally underground pit box in which the antenna is installed to a remote receiver.

In an effort to alleviate the problems associated with physically reading utility meters, utility companies have deployed remote meter transmission units. In general, a remote meter transmission unit remotely reads a utility meter and transmits the meter readings or other meter related information, directly or indirectly, back to a utility company. The remote meter transmission units transmit these meter readings, via radio frequency (RF) signals, to a central reading station or data collection unit. In some instances, the RF signal is transmitted over relatively long distances; e.g., a mile or more. Thus, a remote meter transmission unit may require a robust antenna capable of transmitting the meter readings the necessary distances.

The amount of RF energy actually irradiated into the air, as compared with the potential energy that could be radiated is based on a number of factors. These include applied voltage, the amount of current flowing through the antenna, the frequency of the rf signal applied to the antenna, the material from which the antenna is made, the antenna's geometry, and those materials in surrounding space relatively close to the antenna (e.g., a sphere-radius of up to a few wavelengths of the rf signal applied to the antenna). When the space surrounding an antenna varies, the antenna's performance (i.e., the amount of energy radiated therefrom) will correspondingly vary.

Various factors to be considered in designing and implementing an integrated antenna system include, without limitation:

frequency of operation;

transmitter output power;

antenna gain, polarization, characteristic impedance, geometry, and radiation pattern;

azimuth beam-width and variation;

coefficient of maximum wave reflection;

location where the antenna will be installed;

ability to effect antenna installation;

desired length of service;

ability to operate in exposed environmental conditions (such as exposure to water) with only very small variations in operation performance (due to any water absorption into the antenna system);

resistance to ultra-violet light;

shock and vibration resistance;

environmental temperature variability resistance; and,

government regulations for operating radio equipment.

At the same time, the utility must be aware of cost factors and the ability to manufacture a large volume of such units (for use in a full system having a number of meter reading locations) that are reliable and exhibit repeatability of performance.

### BRIEF SUMMARY OF THE INVENTION

According to one aspect, an antenna used for transmitting utility usage data includes a substrate and a ground plate disposed on the substrate. The antenna has a driving element that adheres to the substrate and is electrically connected to the ground plate. This driving element includes a feed point which an input current signal is supplied. The antenna includes a first parasitic element and a second parasitic element both of which adhere to the substrate and are electrically connected to the driving element and ground plate. The first parasitic element is of a first length and the second parasitic element is of a second and different length. The parasitic elements are responsive to the input signal to generate a dual resonance output.

Other objects and features will be in part apparent and in part pointed out hereinafter.

### BRIEF DESCRIPTION OF THE SEVERAL VIEWS OF THE DRAWINGS

The accompanying figures, together with the detailed description which follows, form part of the specification and illustrate the various embodiments described in the specification.

FIG. 1A is a diagram illustrating components of an exemplary antenna arrangement of the invention together with features of a conventional pit box in which the arrangement is installed;

FIG. 1B is a diagram illustrating a top view of an antenna component mounted to a conventional pit lid;

FIG. 2 is a cross-sectional view of the antenna component and pit lid;

FIG. 3 is an isometric view of an exemplary trident antenna according to an aspect of the antenna arrangement; and,

FIG. 4 is a return loss graph illustrating reflection loss as a function of the frequency of the trident antenna.

Corresponding reference characters indicate corresponding parts throughout the drawings.

### DETAILED DESCRIPTION OF INVENTION

The following detailed description illustrates the invention by way of example and not by way of limitation. This description clearly enables one skilled in the art to make and use the invention, and describes several embodiments, adaptations, variations, alternatives and uses of the invention, including what is presently believed to be the best mode of carrying out the invention. Additionally, it is to be understood that the invention is not limited in its application to the details of construction and the arrangement of components set forth in the following description or illustrated in the drawings. The invention is capable of other embodiments and of being practiced or carried out in various ways. Also, it will be understood that the phraseology and terminology used herein is for the purpose of description and should not be regarded as limiting.

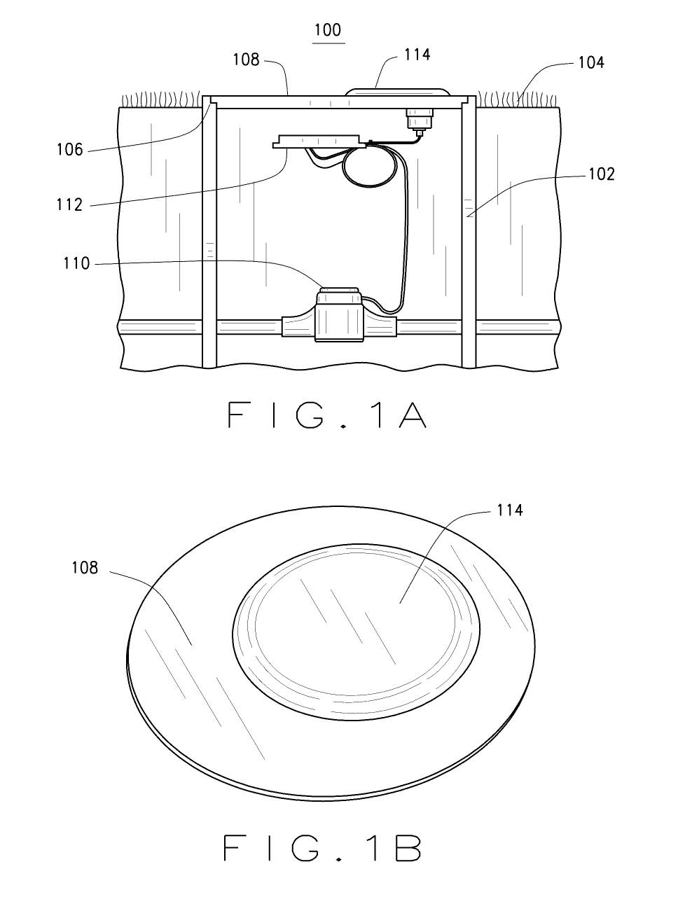

Referring to the drawings, FIG. 1A is a cross-sectional view of an antenna arrangement 100 installed in a conventional pit box 102. As is described hereinafter, components of the exemplary embodiment of an antenna arrangement 100 cooperate and interact with features of pit box 102. As shown in FIG. 1A, pit box 102 extends below a ground surface 104 and is typically a cylindrical, metal enclosure that is substantially installed below ground level. The pit box includes an upper ledge 106 that supports a pit lid 108. The pit lid is preferably formed of metallic material; e.g., steel, cast iron, or from various other materials such as plastic or concrete. Pit lid 108 and pit box 102 together enclose a utility meter 110, such as a water meter.

A meter transmission unit (MTU) 112 attached to water meter 110 receives volumetric flow data from the meter. For example, in some aspects, meter 110 is outfitted with at least one sensor (not shown) to detect rotational movement of components within the meter which action produces an electrical signal representing a measurement of the volume of a commodity (e.g., water) flowing through the meter. MTU 112 is also electrically and/or communicatively coupled to an antenna component 114 of antenna arrangement 100 to transmit meter measurements over a Federal communications Commission (FCC) licensed wireless channel. This communications channel is, for example, at 460 MHz Antenna component 114 is designed to be adaptively integrated with and/or mounted to pit lid 108, this being as shown in FIG. 1B.

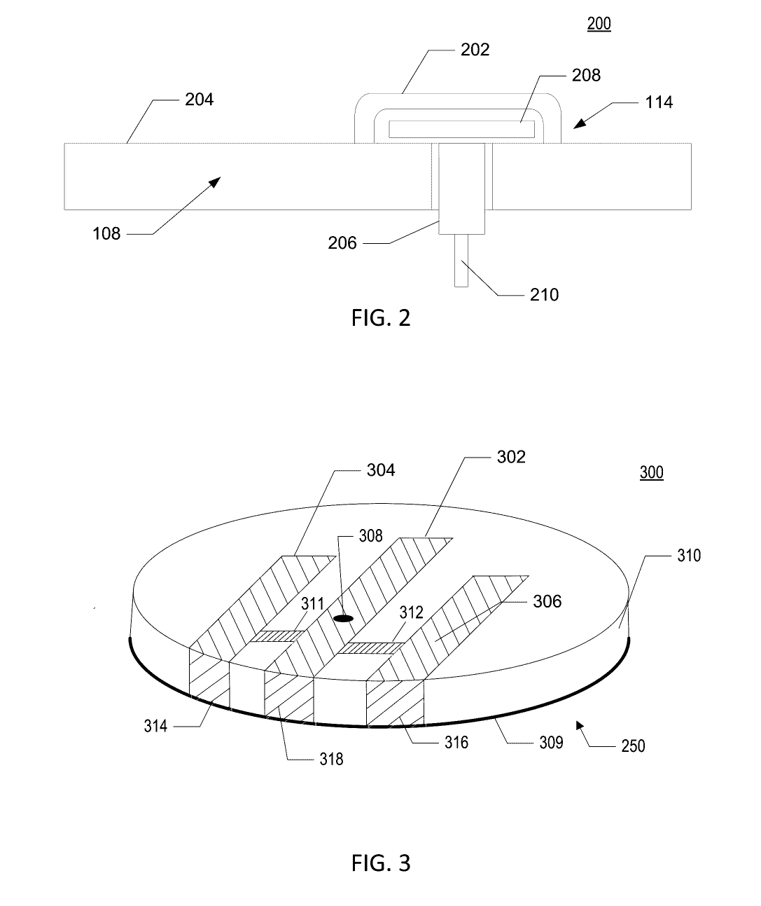

Referring to the cross-sectional view 200 shown in FIG. 2, antenna component 114 includes a housing 202 supported on a top surface 204 of pit lid 108. Antenna component 114 includes an extension member 206 that extends vertically through pit lid 108 to enable the antenna component to be secured in place using any convenient means of securement. For example, although not shown, extension member 206 may include threads onto which a retaining nut is threaded to secure the antenna component in place. Antenna component 114 further includes an antenna 208 that is driven or excited by a current from MTU 112 so to generate and broadcast a rf signal that is detected and read at a remote location such as a data collection unit (not shown). According to one aspect, antenna component 114 includes a cable 210; for example, a rf coaxial cable, to facilitate a wired connection with MTU 112.

FIG. 3 is an isometric view of an antenna 300 (e.g., antenna 208) according to an aspect of the invention. Antenna 300 is, for example, a trident antenna that includes a driving element 302, a first parasitic element 304, a second parasitic element 306, a feed point 308, and a ground plate 309 disposed on a substrate 310.

The material from which driving element 302, first parasitic element 304, second parasitic element 306, and ground plate 309 are formed is an electrically conductive material which is disposed on substrate 310. This material includes, for example, copper, brass, or aluminum. Driving element 302, first parasitic element 304 and second parasitic element 306, and the ground plate 309 all are adhered to substrate 310 by, for example, etching them onto the substrate or inking them onto the substrate.

Substrate 310 is a dielectric substrate. For example, the substrate may be a printed circuit board (PCB) made of a fiberglass reinforced epoxy resin (FR4), a Bismaleimide-triazine (BT) resin, or any other nonconductive or insulating material.

A first conductor (not shown) of cable 210 of antenna component 114 is electrically coupled to driving element 302 at feed point 308 in order to receive an input current signal from MTU 112. A second conductor (also not shown) is electrically coupled to ground plate 309 which forms the bottom surface of substrate 310.

The first and second parasitic elements 304, 306 are each connected to driving element 302 though traces 311, 312, respectively, to effect a short circuit connection between each of the parasitic elements 304, 306 and driving element 302. The first and second parasitic elements 304, 306 are connected to ground plate 309 through traces 314, 316, respectively, to establish a short circuit connection between each of the parasitic elements and ground plate 309. Similarly, driving element 302 is connected to ground plate 309 through a trace 318 to establish a short circuit connection between the driving element and the ground plate.

According to one aspect, parasitic elements 304, 306 have slightly different lengths, which results in a dual resonance in response to an input current signal received at feed point 308. For example, if the differential length of the two parasitic elements is 0.090 inches, dual resonances occur which result in there being less than 10 dB of return loss when operating in a frequency range from 450 MHz to 470 MHz. The dual resonances are close in frequency which produces a wide bandwidth aggregate response. According to one aspect, there two resonant peaks will result which are sufficiently close together so to efficiently radiate over at least 4.35% of the RF carrier bandwidth.

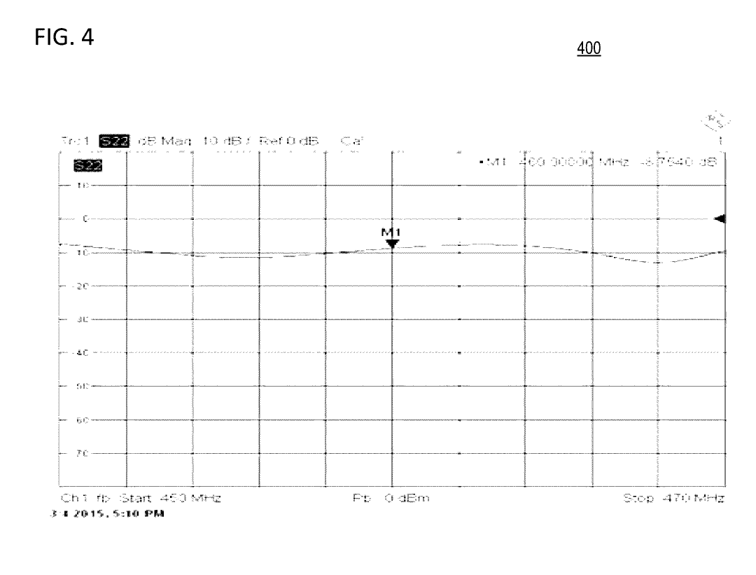

FIG. 4 presents a return loss graph 400 illustrating reflection loss with respect to frequency for the trident antenna arrangement 300 of FIG. 3. The return loss of the antenna 300 may refer to either reflection loss with respect to a frequency of antenna 300, or the difference in power (expressed in decibels (dB)) between input power and power reflected back by the load due to a mismatch.

The super-imposed radiation pattern of the dual parasitic antenna arrangement 300, resonated in the far field, present a nearly uniform azimuth radiation pattern. The operation of driving element 302 and parasitic elements 304, 306 over substrate 310 and ground plate 309 allows antenna arrangement 300 to be minimally impacted by the conductive material underneath.

For purposes of illustration, programs and other executable program components, such as the operating system, are illustrated herein as discrete blocks. It is recognized, however, that such programs and components reside at various times in different storage components of a computing device, and are executed by a data processor(s) of the device.

In view of the above, it will be seen that several advantages of the aspects of the invention are achieved and other advantageous results attained.

Having thus described the invention, what is claimed and desired to be secured by Letters Patent is:

1. An antenna arrangement comprising:
a driving element comprising a feed point to receive an input current signal;
a first parasitic element and a second parasitic element each being electrically connected to the driving element, the first parasitic element having a first length and the second parasitic element having a second and different length, the first and second parasitic elements being responsive to the input signal to generate a dual resonance.

2. The antenna arrangement of claim 1 further including a substrate and a ground plate disposed on the substrate, the driving element and the first and second parasitic elements each adhering to the substrate and being electrically connected to the ground plate.

3. The antenna arrangement of claim 2 in which the substrate is formed of a dielectric material.

4. The antenna arrangement of claim 3 wherein the substrate comprises a printed circuit board which is attached to the ground plate.

5. The antenna arrangement of claim 1 wherein the differential length between the first and second parasitic elements is approximately 0.090 inches, and the resulting dual resonances which occur result in there being less than 10 dB of return loss when the antenna arrangement operates in a frequency range of between approximately 450 MHz to approximately 470 MHz.

6. The antenna arrangement of claim 2 which is installed in a pit box which extends below a ground surface, the pit box comprising a, metal enclosure having an upper ledge supporting a pit lid, the pit box and pit lid together enclosing a utility meter.

7. The antenna arrangement of claim 6 in which the utility meter is a water meter.

8. The antenna arrangement of claim 6 further including a meter transmission unit electrically connected to the utility meter, the meter transmission unit being electrically and/or communicatively coupled to an antenna component of the antenna arrangement so to transmit meter measurements over a FCC licensed wireless channel, and the antenna component being integrated with and/or mounted to the pit lid.

9. The antenna arrangement of claim 7 wherein the antenna component includes a housing supported on a top surface of the pit lid, and the antenna component further includes an extension member extending through the pit lid to enable the antenna component to be secured in place.

10. A trident antenna comprising:
a driving element, a first parasitic element and a second parasitic element 306, a feed point, and a ground plate disposed on a substrate, the driving element, first and parasitic elements, and the ground plate being formed of an electrically conductive material disposed on the substrate; and,
wherein there is a differential length between the first and second parasitic elements of approximately 0.090 inches which results in dual resonances occurring and further result in there being less than 10 dB of return loss when the trident antenna operates in a frequency range of between approximately 450 MHz to approximately 470 MHz.

11. The antenna arrangement of claim 10 in which the substrate is formed of a dielectric material.

12. The antenna arrangement of claim 11 wherein the substrate comprises a printed circuit board which is attached to the ground plate.
